(19) United States
(12) Patent Application Publication
(10) Pub. No.: US 2016/0364094 A1
(43) Pub. Date: Dec. 15, 2016

(54) DISPLAY APPARATUS AND CONTROL METHOD THEREOF

(71) Applicant: SAMSUNG ELECTRONICS CO., LTD., Suwon-si (KR)

(72) Inventors: Seung-min SHIN, Seoul (KR); Sung-pil HWANG, Suwon-si (KR); Seung-won KIM, Seoul (KR); Je-youn DONG, Suwon-si (KR)

(73) Assignee: SAMSUNG ELECTRONICS CO., LTD., Suwon-si (KR)

(21) Appl. No.: 15/177,539

(22) Filed: Jun. 9, 2016

(30) Foreign Application Priority Data
Jun. 10, 2015 (KR) 10-2015-0081810

(51) Int. Cl. G06F 3/0482; G06F 3/0484

(52) U.S. Cl. CPC G06F 3/0482; G06F 3/0484

(57) ABSTRACT

A display apparatus includes: a display; a storage; and a controller configured to display a first GUI including a plurality of menu items corresponding to a plurality of functions respectively on the display, perform a function corresponding to a menu item selected by a user among the plurality of menu items, store history information including information on the selected menu item and information on a time when the menu item is selected, and in response to receiving a request for a GUI, display on the display a second GUI including at least one menu item selected based on the history information and a time when the request for the GUI is received. Thus, the user may easily select preferred function that the user uses at a specific time which results in an improvement of a usability of the functions.

### CROSS-REFERENCE TO RELATED APPLICATION

This application claims priority from Korean Patent Application No. 10-2015-0081810, filed on Jun. 10, 2015 in the Korean Intellectual Property Office, the disclosure of which is incorporated herein by reference in its entirety.

### BACKGROUND

Field

Apparatuses and methods consistent with the exemplary embodiments relate to a display apparatus and control method thereof for displaying a user's preferred function, and more particularly to a display apparatus and a control method thereof for determining a user's preferred function in a particular timeline based on a usage history and for displaying a menu item corresponding thereto.

Description of the Related Art

A display apparatus processes an image signal and/or image data which is transmitted by various external image sources or is stored in the display apparatus. Such display apparatus includes a display, which displays a processed image. For example, the display apparatus may include a TV or a monitor. If the display apparatus is a TV, the display apparatus performs various image processing processes such as decoding and scaling of a broadcast signal provided from the exterior and displays an image of a desired broadcasting channel on a display.

In line with development of technology and diverse demands from users, the display apparatus provides more diverse functions. However, users who use the display apparatus do not always use all of functions of the display apparatus. Rather, the users use familiar functions in accordance with their usage patterns.

Since a related art display apparatus displays all of menu items at a time, a user should perform manipulations inconveniently each time the user searches for a menu item to use a desired function, from all menu items.

To solve the foregoing problem, a related art display apparatus separately provides a user with items of functions which have been used more than other functions, attempting to improve usability of the display apparatus.

However, the related art display apparatus merely provides a user with the item of frequently used functions by only determining the number of usage of the functions, failing to take into account a great difference in the usage pattern that takes places depending on the timeline when a user uses the functions.

### SUMMARY

Exemplary embodiments may address at least the above problems and/or disadvantages and other disadvantages not described above. Also, exemplary embodiments are not required to overcome the disadvantages described above, and may not overcome any of the problems described above.

One or more exemplary embodiments provide a display apparatus and a control method thereof which analyzes and provides a user's preferred function in a particular timeline for the purpose of improving usability of functions is provided.

According to an aspect of an exemplary embodiment, there is provided a display apparatus including: a display; a storage; and a controller configured to: display on the display a first graphical user interface (GUI) including a plurality of menu items corresponding to a plurality of functions respectively, perform a function corresponding to a menu item selected by a user among the plurality of menu items, store history information including information on the selected menu item and information on a time when the menu item is selected, and in response to receiving a request for a GUI, display on the display a second GUI including at least one menu item selected based on the history information and a time when the request for the GUI is received Thus, usability of functions may be improved.

The controller, based on the history information, may increase or decrease a preference of at least one function of the plurality of functions, determine a function having the preference equal to or more than a first threshold to be a user's preferred function, and display the second GUI including the at least one menu item corresponding to the user's preferred function on the display. Thus, standards for determining the preferred function may be provided.

The controller may exclude a function having the preference equal to or less than a second threshold from the user's preferred function. Thus, only functions preferred by a user may be displayed as the GUI.

The controller may additionally increase or decrease the preference of the at least one function based on a frequency of the user selecting the menu item corresponding to the at least one function. Thus, the frequency of using the functions may be taken into account more clearly.

The controller may increase or decrease the preference of the at least one function differently depending on whether the at least one of the function is the user's preferred function or not. Thus, reliability on determining the preferred function may be improved.

The controller may determine at least one function of the plurality of functions to be a user's preferred function based on a user's function usage pattern, and display a third GUI including at least one menu item corresponding to the user's preferred function based on a user's function usage pattern on the display in response to the user's particular function usage pattern of is being detected. Thus, a user's convenience may be enhanced.

The function usage pattern may include using at least one function after at least one of a plurality of image contents is being selected to be displayed. Thus, the selection of the image content by a user and the function usage pattern of using the related function may be further taken into account.

The function usage pattern may include selecting at least one channel after scanning a plurality of channels. Thus, the function usage pattern of selecting the channel by a user after the channel scanning may be further taken into account.

The function usage pattern may include using a first function followed by using a second function. Thus, a user's consecutive function usage pattern may be further taken into account.

The controller may display a fourth GUI on the display for a user to edit the preferred function. Thus, a user's convenience may be taken into account.

According to an aspect of an exemplary embodiment, there is provided a control method of a display apparatus including: displaying a first graphical GUI including a plurality of menu items corresponding to a plurality of functions respectively; performing a function corresponding to a menu item selected by a user among the plurality of menu items; storing history information including information on the selected menu item and information on a time when the menu item is selected; and in response to receiving a request for a GUI, displaying a second GUI including at least one menu item selected based on the history information and a time when the request for the GUI is received. Thus, usability of functions may be improved.

The displaying the second GUI may include increasing or decreasing a preference of at least one function of the plurality of functions based on the history information; determining a function having the preference equal to or more than a first threshold to be a user's preferred function; and displaying the second GUI including the at least one menu item corresponding to the user's preferred function at the GUI request time. Thus, standards for determining the preferred function may be provided.

The displaying the second GUI may further include excluding a function having the preference equal to or less than a second threshold from the user's preferred function. Thus, only functions preferred by a user may be displayed as the GUI.

The displaying the second GUI may further include additionally increasing or decreasing the preference of the at least one function based on a frequency of the user selecting the menu item corresponding to the at least one function. Thus, the actual usage pattern may be taken into account more clearly.

The increasing or decreasing the preference may include increasing or decreasing the preference of the at least one function differently depending on whether the at least one function is the user's preferred function or not. Thus, reliability on determining the preferred function may be improved.

The control method may further include determining at least one function of the plurality of functions to be a user's preferred function based on a user's function usage pattern; and displaying a third GUI including at least one menu item corresponding to the user's preferred function based on the user's function usage pattern in response to the user's particular function usage pattern is being detected. Thus, a user's convenience may be enhanced.

The function usage pattern may include using at least one function after at least one of a plurality of image contents is being selected to be displayed. Thus, the selection of the image content by a user and the function usage pattern of using the related function may be further taken into account.

The function usage pattern may include selecting at least one channel after scanning a plurality of channels. Thus, the function usage pattern of selecting the channel by a user after the channel scanning may be further taken into account.

The function usage pattern may include using a first function followed by using a second function. Thus, a user's consecutive function usage pattern may be further taken into account.

The control method may further include displaying a fourth GUI for a user to edit the preferred function. Thus, a user's convenience may be taken into account.

### BRIEF DESCRIPTION OF THE DRAWINGS

The above and/or other aspects will become more apparent by describing certain exemplary embodiments with reference to the accompanying drawings, in which:

FIG. 1 is a block diagram of a display apparatus according to an exemplary embodiment;

FIG. 2 is a table showing data which is capable of being stored in a storage according to an exemplary embodiment;

FIG. 3 is a flowchart showing operations of the display apparatus according to an exemplary embodiment;

FIG. 4 is a flowchart showing operations of determining a user's preferred function according to an exemplary embodiment;

FIG. 5 is a flowchart showing operations of decreasing a preference of a function according to an exemplary embodiment;

FIG. 6 illustrates a GUI which is displayed by the display apparatus according to an exemplary embodiment;

FIG. 7 illustrates a GUI for editing a preferred function displayed by the display apparatus according to an exemplary embodiment;

FIG. 8 illustrates a GUI for editing a preferred function displayed by the display apparatus according to an exemplary embodiment;

FIGS. 9A and 9B illustrate a GUI for editing a timeline displayed by the display apparatus according to an exemplary embodiment;

FIG. 10 illustrates an image and function displayed by the display apparatus according to an exemplary embodiment;

FIG. 11 is a flowchart showing operations of determining and displaying a preferred function based on a usage pattern with respect to functions according to an exemplary embodiment;

FIG. 12 is a flowchart showing operations of determining and displaying a preferred function based on a usage pattern with respect to functions according to an exemplary embodiment;

FIG. 13 is a flowchart showing operations of determining and displaying a preferred function based on a usage pattern with respect to functions according to an exemplary embodiment; and

FIG. 14 is a flowchart showing operations of displaying and updating a user's preferred function according to an exemplary embodiment.

### DETAILED DESCRIPTION OF EXEMPLARY EMBODIMENTS

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

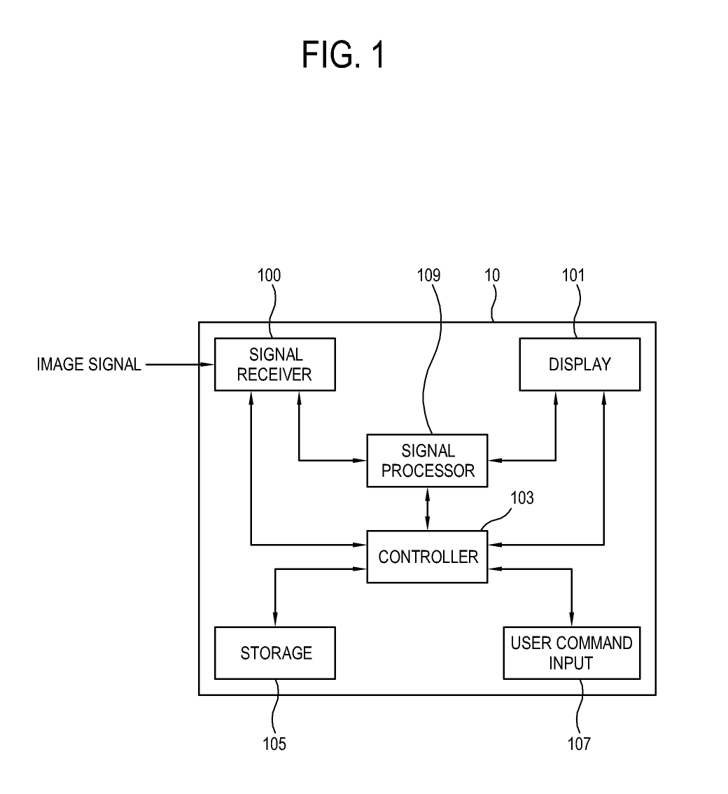

Hereinafter, a display apparatus and a control method thereof for determining a user's preferred function in a particular timeline and for displaying such preferred function according to an exemplary embodiment will be described in detail. FIG. 1 is a block diagram of a display apparatus 10 according to an exemplary embodiment. The display apparatus 10 may include a signal receiver 100, a display 101, a controller 103, e.g., a microprocessor, a storage 105, i.e., a storage device, a user command input 107, i.e., a user input receiver, and a signal processor 109. However, the elements of the display apparatus 10 in FIG. 1 are an embodiment, and may be different therefrom as the case may be. That is, at least one of the elements of the display apparatus 10 may be excluded therefrom or a new element may be added to the display apparatus 10 although it is not shown in FIG. 1.

The signal receiver 100 receives an image signal from the exterior. The signal receiver 100 may include a tuner to receive an image signal. The tuner may be tuned to one of a plurality of channels and may receive an image signal from such channel by control of the controller 103. The selection of the channel may be made by a user's manipulation. For example, the display apparatus 10 may further include the user command input 107 to receive a user's manipulation command. The user command input 107 may directly receive a manipulation command through a manipulation panel or receive a remote control signal including a user's manipulation command from a remote controller.

According to another exemplary embodiment, the signal receiver 100 may receive an image signal from an imaging device such as a set-top box, DVD, PC, etc., or receive an image signal from a peripheral device such as a smart phone or receive an image signal from a server through a network such as the Internet.

The signal processor 109 processes a received image signal to display an image in the display 101. The signal processor 109 may perform, e.g. modulation, demodulation, multiplexing, de-multiplexing, analog-digital conversion, digital-analog conversion, decoding, encoding, image enhancement, or scaling with respect to a received image signal. Also, the signal processor 109 may cause a GUI, which includes a menu item corresponding to a plurality of functions provided by the display apparatus 10, to be displayed in the display 101 by control of the controller 103.

The display 101 displays an image based on an image signal processed by the signal processor 109. The display 101 may display an image by various methods such as LCD, PDP and OLED.

The storage 105 may store various information by control of the controller 103. Also, the storage 105 may store information on a function of the display apparatus 10. The storage 105 may include a non-volatile memory such as a flash memory or a hard disc drive. Data to be stored in the storage 105 may include history information including information on a menu item selected by a user to use a function of the display apparatus 10 and information on a time when a user selected the menu item. Also, the data to be stored in the storage 105 may include various applications for executing a function of the display apparatus 10 as well as an operating system for driving the display apparatus 10.

The controller 103 performs a control operation with respect to various elements of the display apparatus 10. For example, the controller 103 processes an image signal received by the signal receiver 100 and displays the processed image in the display 101. Also, the controller 103 performs a function corresponding to a menu item selected by a user's selection of the menu item, stores in the storage 105 history information including information on the selected menu item and information on the time when a user selected the menu item, analyzes the history information stored in the storage 105, and determines a user's preferred function in a particular timeline. Then, the controller 103 selects, and displays in the display 101, a menu item corresponding to a function which has been determined to be the user's preferred function at the time when a request was made to display the menu item corresponding to the foregoing request.

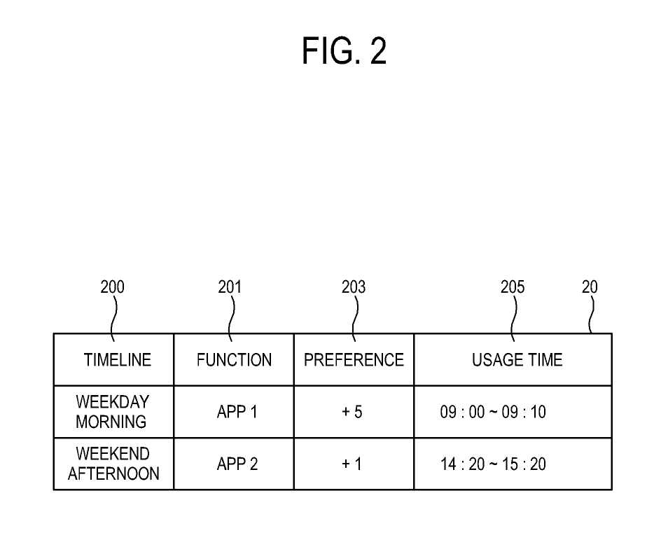

FIG. 2 illustrates a table showing data relating to history information including a menu item selected by a user and time information on a time when a user selected the menu item, as may be stored in the storage 105 according to an exemplary embodiment. If a user selects a menu item of a GUI to use a function 201, the controller 103 performs the function 201 corresponding to the selected menu item. Then, history information including information on the menu item selected by a user and information on a time when a user selected the menu item is stored in the storage 105. Otherwise, information on the function 201 used by a user and a time 205 when a user used the function 201 may be stored in the storage 105. The information may include items relating to a timeline 200, the function 201, a preference 203, e.g., a preference rating, and the time 205. The foregoing information items are just examples, and the stored information item is not limited to those shown in FIG. 2.

The timeline 200 is a range of time including the time 205 when the function 201 was used, and may variously be stored by a user's selection including weekday morning, weekend afternoon, the end of a year, midnight, or early morning. Since with respect to the same function 201, the preference 203 which increases and decreases based on a user's usage may vary depending on the timeline 200, a user's preferred function does not stay the same during the timeline 200. The range and name of the timeline 200 is set in advance, but a GUI may be provided to a user for edition. The GUI for editing the timeline 200 will be described later.

The function 201 is the one performed by the display apparatus 10 as a user selects a menu item of a GUI to use the function 201. The function 201 may be any function which the display apparatus 10 may provide to a user including an application executable by the display apparatus 10, a channel viewed by a user, setting for brightness of a screen, picture quality, etc.

The preference 203 is a number stored by being increased or decreased as a user uses the function 201. The preference 203 increases if a user uses the function 201 more frequently, and decreases if a user does not use the function 201 for a certain period. An increase and decrease of the preference 203 may be used to determine whether a user prefers the function 201.

A usage time 205 is information on a time when a user commences a usage of the function 201 and on a time when he/she ends the usage thereof. The usage time 205 may include information on year/month/date as well as hour/minute/second.

According to another exemplary embodiment, the information stored in the storage 105 may further include various types of information relating to the function 201 and a usage of the function 201 such as user information for identifying a user, the number of usage of the function 201, a period during which the function 201 was not used, a minimum time during which the function 201 may be deemed to have been used, setting of the function 201, etc.

As an example of the user information for identifying a user, if there is a plurality of users using the display apparatus 10, an identification code may be used to identify each user. The storage 105 may additionally store information on a user's age, gender, etc. corresponding to each identification code. As the identification code is used, each user may use the function 201 and the preference 203 may increase or decrease accordingly. Even if a plurality of users uses the same display apparatus 10, a preferred function in the particular timeline 200 may vary depending on each user, and thus a GUI displayed may be different per user.

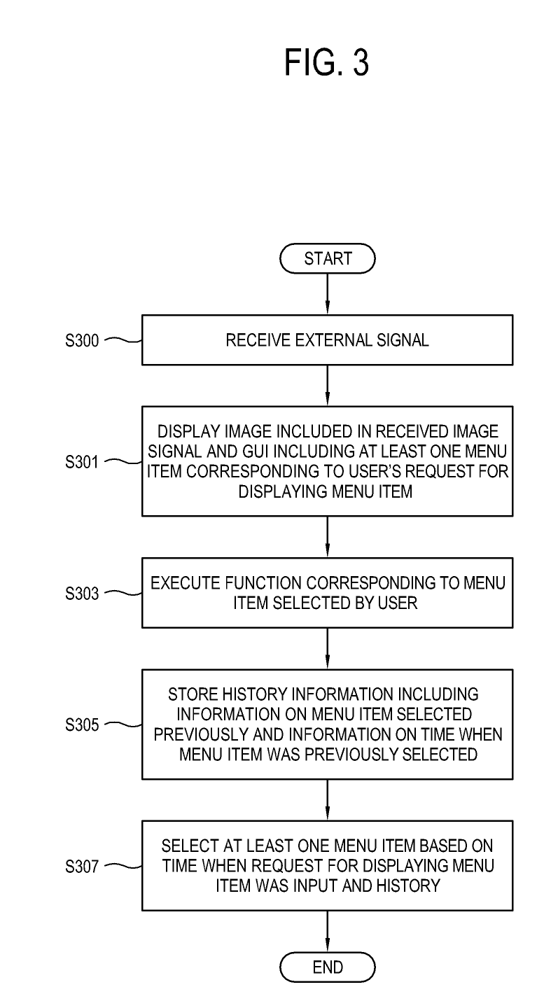

FIG. 3 is a flowchart showing operations of the display apparatus 10 according to an exemplary embodiment. At operation S300, the signal receiver 100 receives an external signal. At operation S301, the controller 103 displays in the display 101 an image included in the received external signal and a GUI including at least one menu item corresponding to a user's request for displaying the menu item. At operation S303, the controller 103 executes a function corresponding to the menu item selected by a user. At operation S305, the controller 103 stores history information including information on the menu item selected previously and information on a time when the menu item was selected previously. At operation S307, the controller 103 selects at least one menu item based on the time when the request for displaying the menu item was input, and the history information.

The signal receiver 100 receives the external signal (operation S300) and provides the signal to the signal processor 109. The signal processor 109 processes the provided signal, and displays in the display 101 an image based on the processed signal by control of the controller 103.

If a user makes a request for displaying a menu item while the image is displayed in the display 101, the image and a GUI including at least one menu item are displayed together in the display 101 by control of the controller 103 (operation S301).

A user may select the menu item of the GUI to use a function of the display apparatus 101, and the controller 103 executes the function corresponding to the selected menu item in accordance with a user's selection of the menu item (operation S303).

Then, history information including information on the menu item previously selected by a user and information on the time when the menu item was selected is stored in the storage 105 (operation S305). As shown in FIG. 2, the timeline 200, the function 201 used, the preference 203 of the function and the time 205 when the function 201 was used may be stored in the storage 105.

Then, the controller 103 selects at least one menu item based on a time when the request for displaying the menu item was input, and the history information stored in the storage 105 (operation S307). The selected menu item may correspond to the preferred function which has been determined to be a user's preferred function. That is, the controller 103 determines the function 201 preferred by a user at the time when the request for displaying the menu item was input or at a particular timing to be a user's preferred function and selects the menu item corresponding to the preferred function as determined above (operation S307). The user's preferred function may be determined based on the preference 203 of the function in the particular timeline 200. The method of determining the preferred function based on the preference 203 will be described later.

Corresponding to a user's future request for displaying a menu item, the controller 103 may display in the display 101 a GUI including a menu item selected on the basis of the time when the request for displaying the menu item was made and the history information. That is, if a request for displaying a menu item is made in a particular timeline, a menu item corresponding to a user's preferred function at the time when such request was made is provided for a user to easily select the menu item, and thus, a user may select the displayed menu item and use a corresponding function. The displayed menu item may be different from the at least one menu item displayed at operation S301. If a user uses a function of the display apparatus 10 for a long time, the same menu item may be determined to correspond to a user's preferred function at the time when the request was made and thus the displayed menu item may be updated.

According to another exemplary embodiment, the controller 103 may always display in the display 101 a menu item corresponding to a preferred function at a current time even without receiving a request for displaying the menu item. The controller 103 may automatically execute a function, which has been determined to be the preferred function in a particular timeline, when the relevant timeline is started without separately displaying a GUI.

According to another exemplary embodiment, the display apparatus 10 in which a preferred function has been already determined may be provided to a user. After a function usage history of other plural users is analyzed, a prediction model which predicts a preferred function of a user who will use the display apparatus 10 is created. At the beginning of usage, the display apparatus 10 may display a menu item that has been selected corresponding to a predetermined function which has been determined by using the prediction model. The preferred function which has been determined by the prediction model is not necessarily identical to a user's preferred function, but it may be fairly identical thereto since it has been based on the usage history of the plural users. If a user uses the display apparatus 10 for a relatively long period thereafter, the preferred function is updated to a function that a user actually prefers.

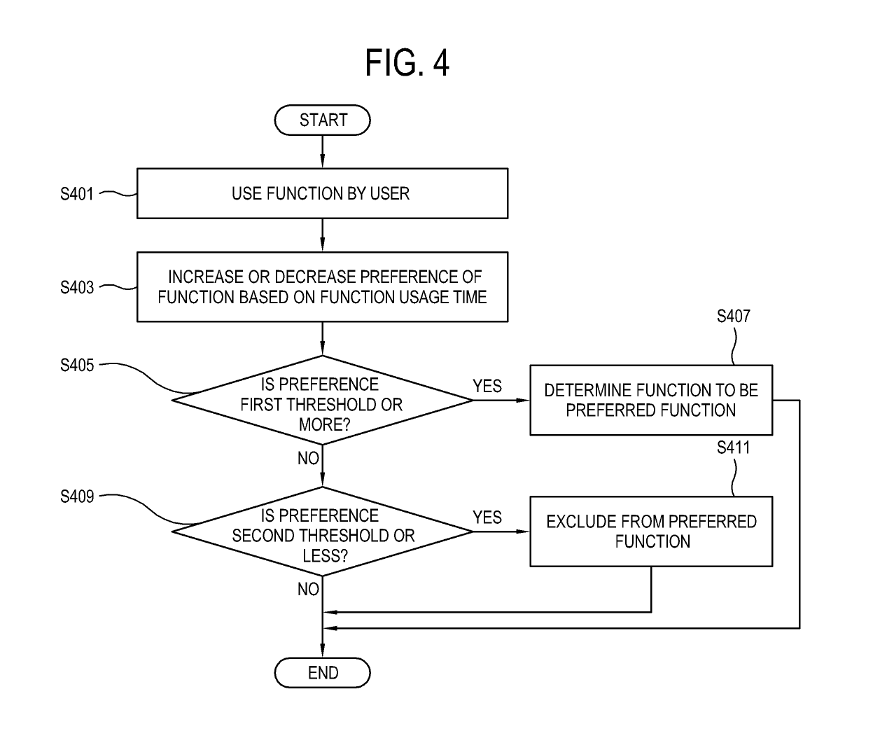

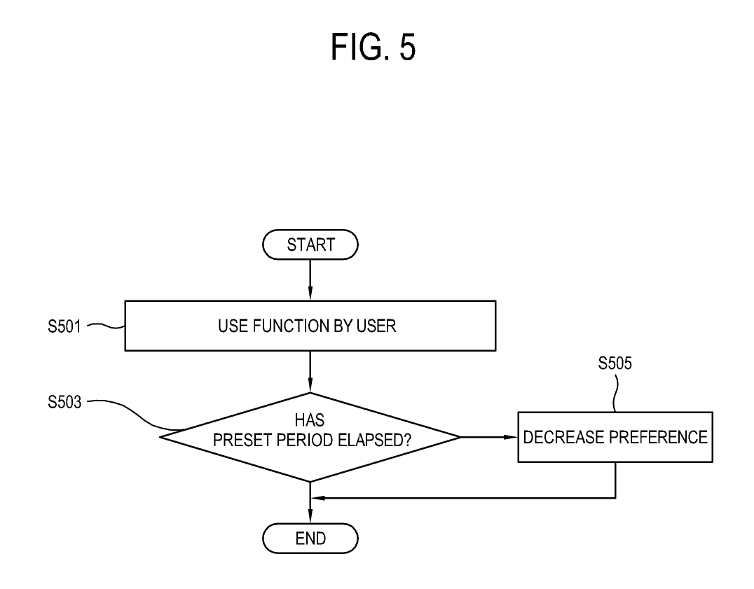

FIG. 4 is a flowchart showing operations of determining a preferred function in accordance with an increase and decrease of the preference 203 according to an exemplary embodiment. FIG. 5 is a flowchart showing operations of decreasing a preference of the function 201. The preference 203 of the function 201 may increase or decrease as a user uses the function 201. The preference 203 is a number for determining whether a user prefers the function 201 and is stored in the storage 105. If the preference 203 increases beyond a preset first threshold, it means a user uses the function 201 frequently and thus the function 201 may be determined to be a preferred function. If the preference 203 decreases and becomes less than a preset second threshold, it means a user does not prefer the function 201 anymore and thus the function 201 may be excluded from the preferred function.

At operation S401, a user uses the function 201. At operation S403, the controller 103 increases or decreases the preference 203 of the function 201 in the particular timeline 200 based on the function 201 used and the time 205. At operation S405, the controller 103 determines whether the preference 203 of the function 201 is the first threshold or more. If it is determined that the preference 203 of the function 201 is the first threshold or more, the controller 103 determines the function 201 to be the preferred function at operation S407. If the preference 203 of the function 201 is not the first threshold or more, the controller 103 determines whether the preference 203 of the function 201 is the second threshold or less at operation S409. If the preference 203 of the function 201 is the second threshold or less, the controller 103 excludes the function 201 from the preferred function at operation S411.

If a user uses at least one function 201 selected by him/her from a plurality of functions which may be provided by the display apparatus 10 (operation S401), information 20 on the function 201 used by a user and the time 205 during which a user used the function 201 is stored in the storage 105. The information 20 has been described above.

Based on the time 205, during which a user used the function 201, as included in the history information stored in the storage 105, the controller 103 increases or decreases the preference 203 in the timeline 200 in which the function 201 was used (operation S403). The controller 103 increases the preference 203 whenever a user uses the function 201. Determining on whether a user used the function 201 may be made if a user accesses the function 201, i.e. selects the menu item, or according to another exemplary embodiment, if a user used the function 201 for predetermined time or more. The predetermined time which may be a basis for determining that a user used the function 201 may vary by each function 201. Also, the increase or decrease in the preference 203 may vary by each function 201.

FIG. 5 is a flowchart showing operations of decreasing the preference 203 of the function 201. After a user used the function 201 (operation S501), the controller 103 determines that a predetermined period has elapsed (operation S503). If the predetermined period elapsed, the preference 203 of the function 201 in the particular timeline 200 is decreased (operation S505). Regardless of whether the function 201 was used for the preset period, the controller 103 decreases the preference 203 if the preset period elapses.

In another exemplary embodiment, if the function 201 was used for a preset period, the controller 103 may initialize the calculation of the preset period and may elect not to decrease the preference 203. The preset period which is used as a basis for decreasing the preference 203 may be set differently by each function 201, and relevant information may be stored in the storage 105.

In another exemplary embodiment, the controller 103 additionally increases or decreases the preference 203 of the function 201 in the timeline 200 in which the function 201 was used, based on a frequency of using the function 201 by a user. More specifically, if the function 201 is used for a predetermined frequency or more during a preset period, the controller 103 may additionally increase the preference 203 of the function 201 whenever the function 201 is used. Also, if the preference 203 of the function 201 is continuously decreased without an increase, the controller 103 may additionally decrease the preference 203 of the function 201.

In another exemplary embodiment, the controller 103 may vary a degree of increase or decrease of the preference 203 depending on whether the function 201 is a preferred function. If the function 201 used is a preferred function, the controller 103 may increase the preference 203 more or decrease it less than the case where the function 201 is not the preferred function. On the contrary, if the function 201 used is not the preferred function, the controller 103 may increase the preference 203 more or decrease it less than the case where the function 201 is the preferred function.

To determine whether the function 201 is the preferred function, the controller 103 determines whether the preference 203 of the function 201 is the first threshold or more (operation S405). The function 201 whose preference 203 in the particular timeline 200 is the first threshold or more means that a user prefers to use the function 201 in the particular timeline 200. Thus, if the preference 203 of the function 201 is the first threshold or more, the controller 103 determines the function 201 to be a user's preferred function in the particular timeline 200 (operation S407). If the function 201 is already the user's preferred function, whether the preference 203 of the function 201 is the first threshold or more is not determined.

If the preference 203 of the function 201 is not the first threshold or more, the controller 103 determines whether the preference 203 of the function 201 is the second threshold or less (operation S409). The function 201 whose preference 203 in the particular timeline 200 is the second threshold or less means that a user does not prefer to use the function 201 in the particular timeline 200 anymore. Thus, if the preference 203 of the function 201 is the second threshold or less, the controller 103 excludes the function 201 from the user's preferred function (operation S411). If the function 201 is not already the user's preferred function, whether the preference 203 of the function 201 is the second threshold or less is not determined. If the function is the preferred function, and if the preference 203 of the function 201 is decreased to the second threshold or less, the function 201 may be excluded from the preferred function and a corresponding menu item may not be displayed anymore. The second threshold may be equal to the first threshold, but may also be lower than the first threshold to prevent a function selected as the preferred function from being easily excluded from the preferred function.

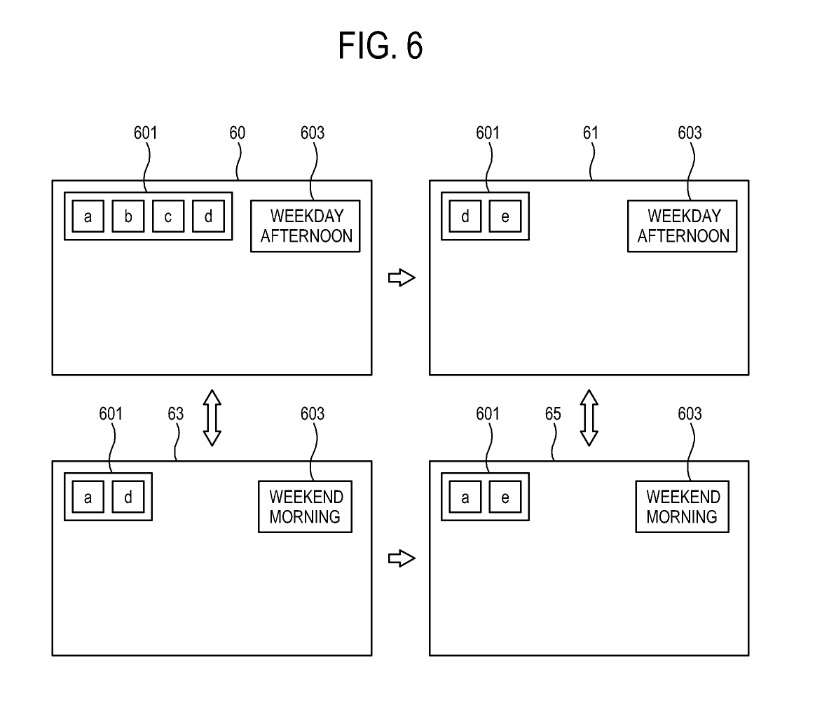

FIG. 6 illustrates an example of the display 101 which displays a GUI according to an exemplary embodiment. A GUI including at least one menu item 601 selected based on history information and a timeline 603 is displayed in the display 101. The display 101 displays a GUI 60 including a menu item 601 a, b, c and d corresponding to a function preferred by a user in weekday afternoon, and an item 603 corresponding to a current timeline. The display 101 displays a GUI 61 including a menu item 601 a and b corresponding to a function preferred by a user in weekend afternoon, and an item 603 corresponding to a current timeline.

The GUIs 60 and 61 including the at least one menu item 601 corresponding to a user's preferred function and the current timeline 603 may be displayed in the display 101 at a user's request. The timeline 603 means a range of time including the time when the request for displaying the menu item was made, and may be displayed as the timeline 603 or as a current exact time. The menu item 601 corresponds to a function which has been determined to be a user's preferred function at the time when the request for displaying the menu item was made.

Otherwise, even if a user's control command is not particularly input, the GUIs 60 and 61 including at least one menu item 601 corresponding to a user's preferred function and the current timeline 603 may be automatically displayed in the display 101. The layout and explanation on the displayed GUIs 60 and 61 are just an example, and the GUIs 60 and 61 may vary depending on the method of achieving the GUIs 60 and 61.

If the GUIs 60 and 61 are displayed and a user further uses the display apparatus 10 for a certain period, the user's preferred function is updated and thus the display 101 displays GUIs 63 and 65 including another menu item 601 even in the same timeline 603.

The GUIs 60 and 61 and the GUIs 63 and 65 which are displayed by the display 101 may be those displayed for different users. This is because even if two display apparatuses 10 store the same preferred function at the beginning, the preferred function in the same timeline 603 may be updated and thus become different by usage for a long time. As a user continuously uses the display apparatus 10, the preferred function displayed in a screen will be those that a user truly prefers.

In another exemplary embodiment, the menu item 601 corresponding to the preferred function is not included in the GUI to be displayed in the display 101, and instead the preferred function may be directly executed. For example, when a user changes a channel, a preferred channel is not provided as the menu item 601, and if a user selects a next channel, the channel may be naturally changed to a channel displaying a preferred image. According to this embodiment, a channel selected may vary depending on a user using the display apparatus 100, depending on a period during which a user used the display apparatus 10, or when a next channel is selected.

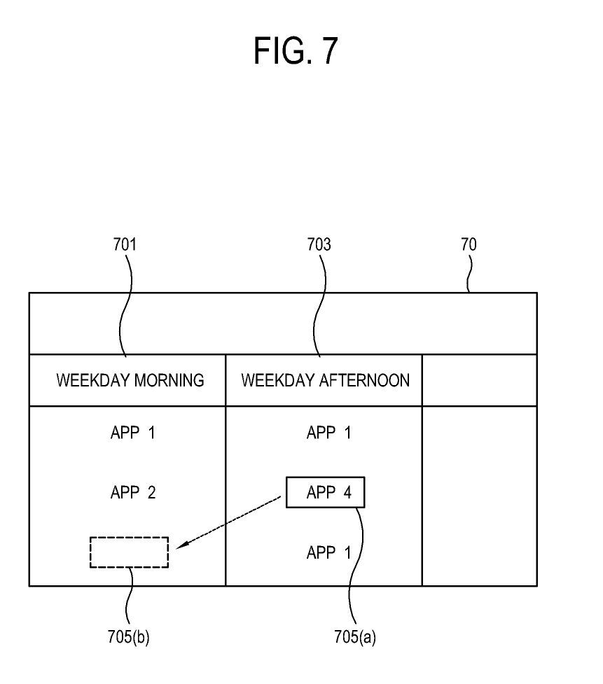

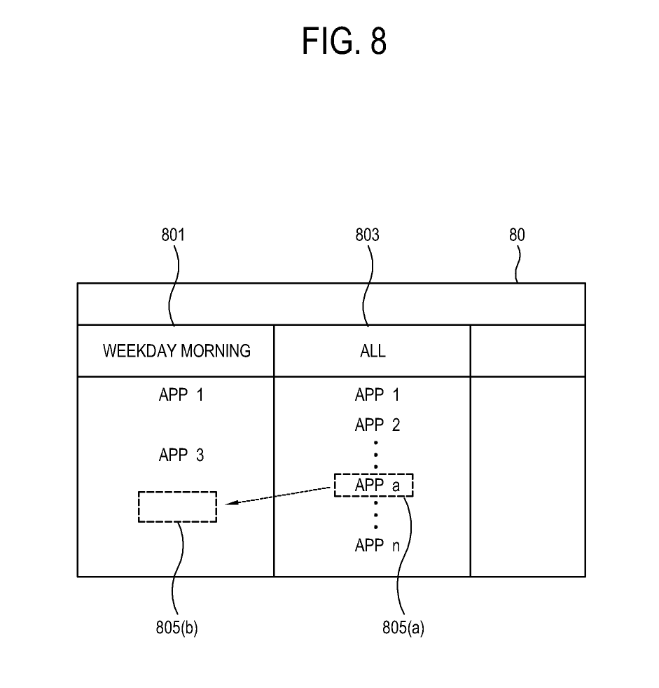

FIGS. 7 and 8 illustrate an example of GUIs 70 and 80 which are displayed for a user to edit a preferred function according to an exemplary embodiment. Determining a user's preferred function by the controller 103 based on the preference 203 may be convenient, but the user's preferred function determined by the controller 103 may be inconsistent with the function 201 that a user actually prefers and desires to use without difficulty. To prevent such inconsistency, the GUIs 70 and 80 for editing a preferred function are provided for a user to determine the function 201 as the preferred function on his/her own, to exclude un-preferred function 201 from the preferred function, and change the timeline 200 of the preferred function.

FIG. 7 illustrates an example of an editing GUI 70 for editing a preferred function according to an exemplary embodiment. The GUI 70 is displayed for a user to change the preferred function at a first timeline 701 to a preferred function at a second timeline 703. The editing GUI 70 includes menu items corresponding to preferred functions in the first timeline 701 and the second timeline 703. To determine an APP 1 as one of preferred functions of the second timeline 703 as a preferred function of the first timeline 701, a user may move a menu item 705(a) corresponding to the APP 1 to a blank space 705(b) of the first timeline 701. The movement may be performed by simple and intuitive manipulation such as drag-and-drop or click. If the movement is completed, the APP 1 is excluded from the preferred function of the second timeline 703 and is determined to be the preferred function of the first timeline 701. It is also available to copy and paste the preferred function from the second timeline 703 to the first timeline 701 depending on the embodiment. The foregoing description and the GUI in FIG. 7 are just an example, and there may be various examples of GUIs that are displayed to change the timeline of at least one preferred function.

FIG. 8 illustrates an example of a preferred function editing GUI 80 which is displayed for a user to determine a preferred function among a plurality of functions that the display apparatus 10 may perform according to an exemplary embodiment. The GUI 80 includes a menu item corresponding to a preferred function in a particular timeline 801 and an all functions 803. To select the APP 1, which is one of the all functions 803, as a preferred function in the particular timeline 801, a user may move a menu item 805(a) of the APP 1 to a blank space 805(b) of the particular timeline 801. The movement may be performed by simple and intuitive manipulation such as drag-and-drop or click. If the movement is completed, the moved APP 1 is determined to be the preferred function in the particular timeline 801. Excluding the preferred function in the particular timeline 801 is also available depending on the embodiment. The foregoing description and the GUI in FIG. 8 are just an example, and there may be various examples of GUIs that are displayed to determine at least one preferred function or to exclude a function from the preferred function.

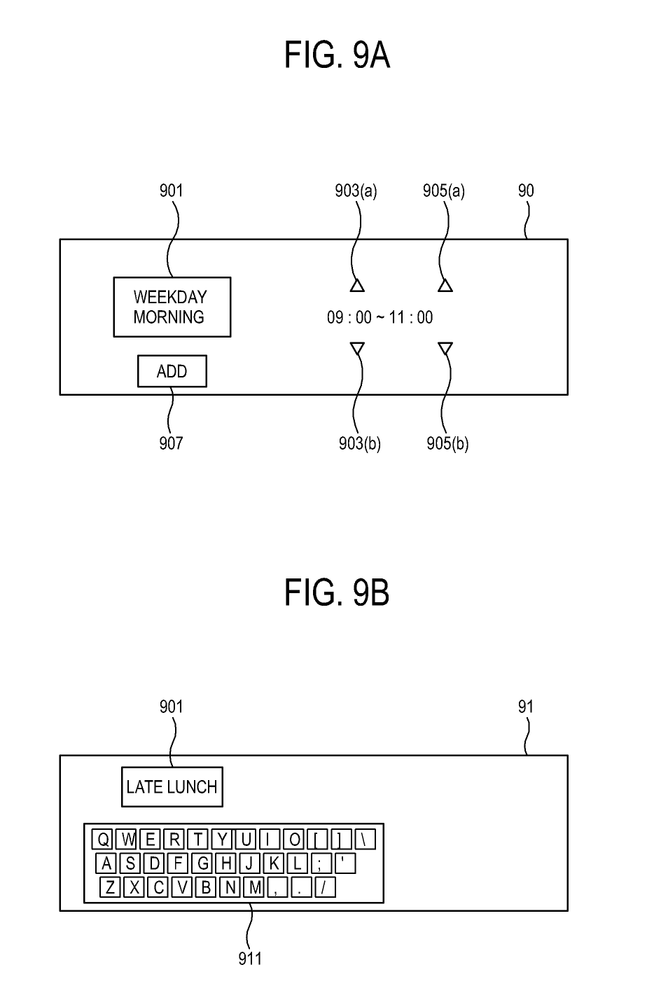

FIGS. 9A and 9B illustrate an example of timeline editing GUIs 90 and 91 which are displayed for a user to edit and add a particular timeline 901 according to an embodiment. The GUI 90 includes the particular timeline 901, a plurality of timeline change buttons 903(a), 903(b), 905(a) and 905(b), and an add button 907. The GUI 91 which is provided to change a name or add the particular timeline 901 further includes a keyboard 911. A user may need a function to change a scope of a timeline and a name of a timeline or to add a new timeline in line with his/her lifestyle and preference. If a user inputs a control command to the display apparatus 10 to edit a preset timeline, the editing GUI 90 is displayed to provide a user with a timeline editing function.

Then, a user may change a scope of the particular timeline 901 by manipulating the displayed GUI. Firstly, a user may determine the particular timeline 901, the scope of which is to be changed, and may change the scope of the particular timeline 901 by manipulating the plurality of timeline change buttons 903(a), 903(b), 905(a) and 905(b). A user may change a starting time of a particular timeline 200 by manipulating a first change button 903(a) and a second change button 903(b), and may change an ending time of the particular timeline 200 by manipulating a third change button 905(a) and a fourth change button 905(b).

A user may change a name of the particular timeline 901 by manipulating the displayed GUI 91. A user may directly input a name by using the keyboard 911 provided through the GUI 91 or select a name from preset items.

If a user selects the add button 907, he/she may add a new particular timeline 200 by manipulating the displayed GUI 91. A user may input a name of the new particular timeline 200 or select the name from preset items, and may change the scope by using the timeline change buttons 903(a), 903(b), 905(a) and 905(b).

The foregoing description and the timeline editing GUIs 90 and 91 in FIGS. 9A and 9B are just an example, and there may be various examples of editing GUIs 90 and 91 that are displayed for a user to change the scope and name of the particular timeline 901 or to add the new particular timeline 901.

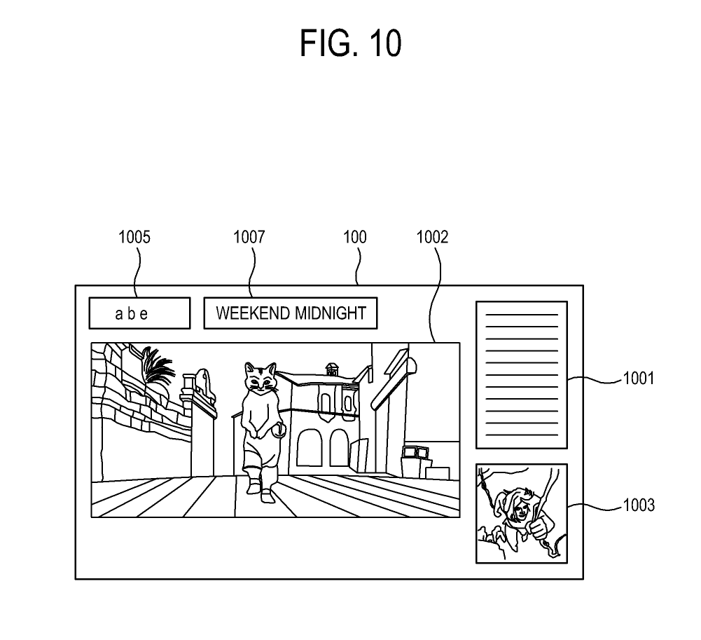

FIG. 10 illustrates an example of the display apparatus 10 in which an image content 1002 selected by a user and functions 1001 and 1003 provided to a user are displayed in the display 100. The display apparatus 10 may display an image content 1002 of a plurality of images received by the display apparatus 10 in accordance with a user's selection. The display apparatus 10 may, together with the image content 1002, display a screen in which the plurality of functions 1001 and 1004 being provided to a user and a GUI including a menu item 1005 selected on the basis of history information in response to a user's request for displaying the menu item and the timeline 1007. The menu item 1005 displayed in the GUI corresponds to a user's preferred function as described above.

As described above, the display apparatus 10 may receive an image signal from the exterior and process the image signal, and display the image content 1002 based on the processed image signal. The external apparatus means all types of devices that may provide an image signal to the display apparatus 10 including a broadcasting station transmitting a broadcast signal, a network server connected in a wireless or wired manner or an external electronic device such as a computer. A user may select the image content 1002 from a plurality of image contents that may be displayed by the display apparatus 10, and view the image content 1002. The selection may be a selection of a channel to which a frequency of a broadcasting station is allocated or a selection of an external device connected to the display apparatus 10.

The display apparatus 10 may, together with the image contents 1002, display in the display 101 all of functions that the display apparatus 10 may provide including image related information 1001 such as subtitles, explanation of the image, picture in picture (PIP) 1003, screen adjustment, channel reservation and various applications.

The display apparatus 10 may display the menu item 1005 corresponding to a user's preferred function in response to a user's request for displaying the menu item 1005 while displaying the image content 1002. The menu item 1005 corresponding to the preferred function may be displayed always even without a user's manipulation.

The display apparatus 10 may display a time 1007 at which a request for displaying a menu item was input. The time 1007 displayed may be an accurate time or a pre-stored timeline 201. As described above, the name and scope of the timeline 201 may be changed by a user.

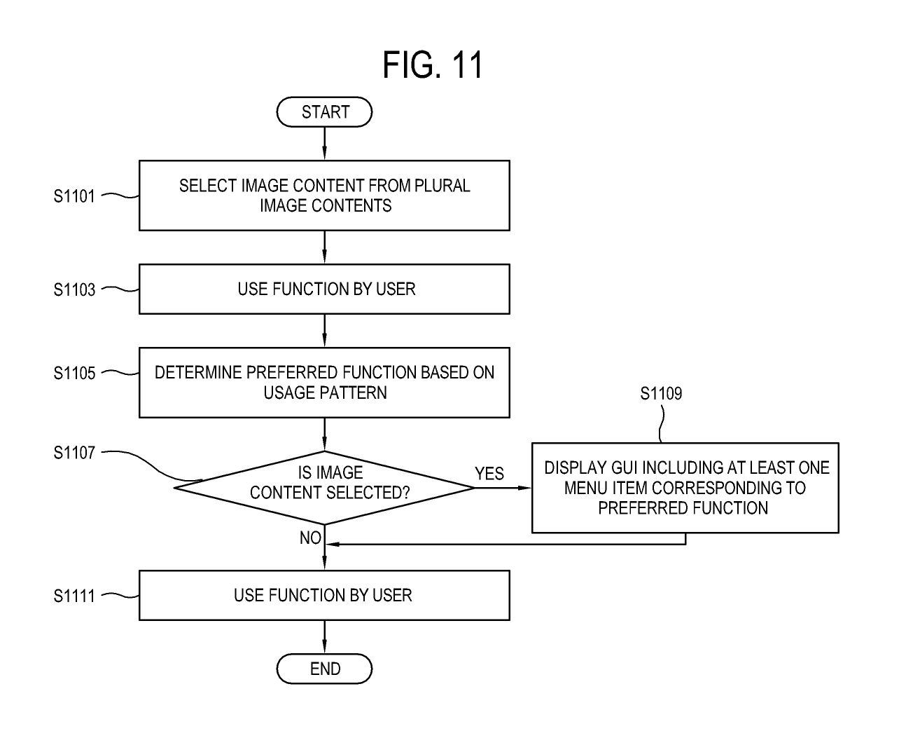

FIGS. 11 to 13 are flowcharts showing operations of determining and displaying a preferred function based on a user's function usage pattern according to an exemplary embodiment. The preferred function may be determined on the basis of a user's usage pattern of the function 201 as well as on the basis of the fact that a user has used the function 201 and the time 205 during which a user used the function 201. The controller 103 may determine the preferred function depending on a user's function usage pattern by analyzing how a user has used the function 201. If the preferred function depending a user's usage pattern of a particular pattern is decided, the controller 103 may provide a user with a GUI asking a user whether to use the determined preferred function whenever the same function usage pattern is present. Below, embodiments for determining a preferred function based on a user's usage pattern and for displaying the preferred function will be described with reference to a screen in FIG. 10 and flowcharts in FIGS. 11 to 13.

FIG. 11 is a flowchart showing operations of determining and displaying a preferred function based on a usage pattern with respect to the function 201 after at least one image content 1002 is selected from a plurality of image contents according to an exemplary embodiment.

While the particular image content 1002 is displayed, a user may use the function 201 of the display apparatus 10. For example, a user may, while watching a baseball game, use the PIP 1003 to see the result of another baseball game in another stadium, or may, while watching a movie, use an information APP 1001 to obtain movie related information. The PIP 1003 or the information APP 1001 used as above, may be determined to be a user's preferred function based on the function usage pattern. Below, operations of determining a preferred function based on a usage pattern with respect to the function 201 and for displaying the preferred function after the image content 1002 is selected will be described.

At operation S1101, the controller 103 displays in the display 101 the image content 1002 selected by a user. At operation S1103, if a user uses the function 201 while the image content 1002 is being displayed, the controller 103 determines the preferred function based on a user's function usage pattern at operation S1105. At operation S1107, the controller 103 determines whether a user has selected the image content 1002 relating to the image content 1002 that a user previously selected. If the image content 1002 relating to the image content 1002 that was previously selected is selected, the controller 103 displays in the display 101 a GUI including the menu item 1005 corresponding to the preferred function as determined at operation S1109. Lastly, at operation S1111, a user selects and uses the function 201.

The controller 103 displays in the display 101 the image content 1002 selected by a user based on the image signal provided from the exterior (operation S1101). A user's control command may be a selection of a particular channel, or a selection of one of a plurality of external devices providing the image content 1002. The display apparatus 10 displays the image content 1002, and stores in the storage 105 information on details of the image content 1002 selected by a user. The information on the details may be a type or length of the image content 1002, information on whether the image content 1002 is a recorded broadcasting and other various information.

If a user uses the function while the image content 1002 is being displayed (operation S1103), the controller 103 may display, together with the image content 1002, in the display 101 image related information such as subtitles and explanation on the image content 1002 and the PIP 1003.

The controller determines a user's preferred function in the current timeline 200 based on a usage pattern of using the function 201 while the image content 1002 is being displayed (operation S1105). The preferred function may be the function 201 that a user used while the image content 1002 was displayed. The preferred function may be determined on the basis of an increase/decrease of the preference 203 as described above.

If a user selects the image content 1002 after the preferred function is selected, the controller 103 analyzes information on the stored image content 1002 and determines whether a user has selected the image content 1002 relating to the image content 1002 that a user previously selected (operation S1107).

If the controller 103 determines that a user has selected the related image content 1002, it displays a GUI including the menu item 1005 corresponding to the determined preferred function, by a user's manipulation (operation S1109).

In another exemplary embodiment, if a user has selected the related image content 1002, the controller 103 may directly display in the display 101 the GUI including the menu item 1005 corresponding to the preferred function or may execute the determined preferred function without displaying the GUI.

For example, if a user used the PIP 1003 several times to see the result of other games while watching a soccer game, the PIP 1003 which a user has used while watching the sport game may be determined to be a user's preferred function based on the function usage pattern. If a user watches a baseball game in the future, the controller 103 may determine that a user has selected a related image content and thus display a GUI including the menu item 1005 corresponding to the PIP 1003 according to a user's manipulation.

According to another exemplary embodiment, if a user selects a baseball game, the GUI including the menu item 1005 corresponding to the PIP 1003 may be directly displayed, or if a user selects a baseball game, the display apparatus 10 may simultaneously display a screen of another stadium by using the PIP 1003.

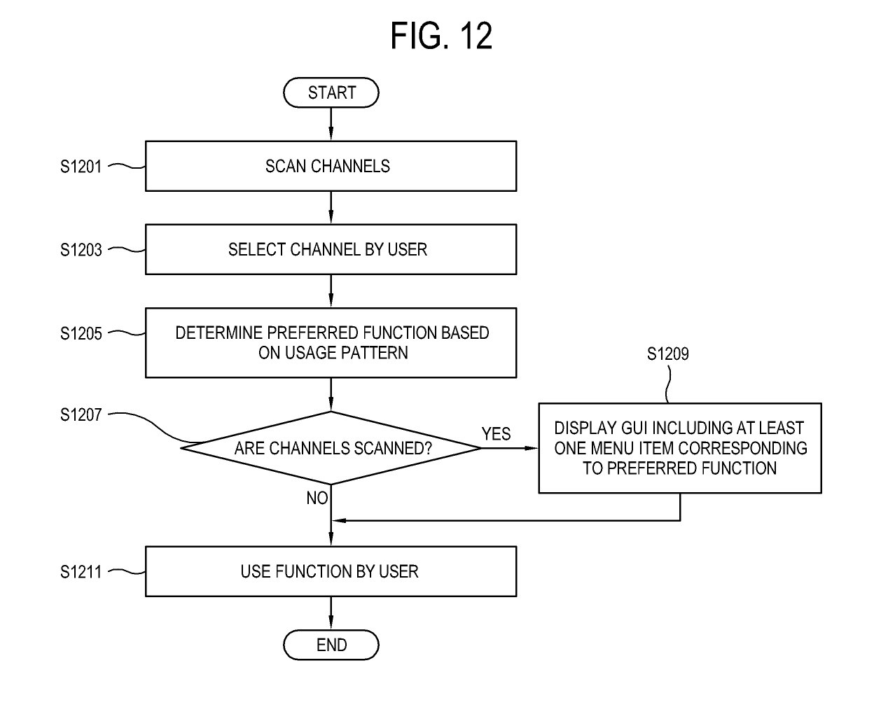

FIG. 12 is a flowchart showing operations of determining a preferred function based on a function usage pattern of selecting a particular channel while a channel is scanned and for displaying the preferred function. The channel scanning means a user's act of randomly changing a channel to find the image content 1002 that a user desires to view. Once a user finds the desired image content 1002 while scanning channels, he/she stops scanning the channels, and views the image content 1002. Selecting the particular image content 1002 after the channel scanning may be deemed a function usage pattern, and the particular image content 1002 which has been selected after the channel scanning may be determined to be the preferred function based on the function usage pattern. Below, operations of determining and displaying a preferred function based on a function usage pattern of selecting a channel and viewing the desired image content 100 after channel scanning will be described.

At operation S1201, a user manipulates the display apparatus 10 for channel scanning. After the channel scanning is completed, a user selects a channel and views the particular image content 1002 at operation S1203. At operation S1205, the controller 103 may determine the preferred function based on a user's function usage pattern. After the preferred function is determined, the controller 103 determines whether that is any channel scanning by a user at operation S1207. If the controller 103 determines that there is a channel scanning by a user, the GUI including the menu item 1005 corresponding to the preferred function determined as above is displayed in the display 101 at operation S1209. Lastly, at operation S1211, a user selects and uses the function 201.

If a user scans channels to find the desired image content 1002 (operation S1201), and selects the particular image content 1002 (operation S1203), the controller 103 stores in the storage 105 information on the image content 1002 selected by a user. Whether there has been the channel scanning is determined depending on whether a user has selected a channel of preset numbers or more, or whether the time during which the selected channel was maintained is a preset time or less.

At operation S1205, the controller 103 determines a user's preferred function based on a user's function usage pattern of selecting the particular image content 1002 after the channel scanning made at S1201. The preferred function may be the provision of the image content 1002 relating to the image content 1002 which was previously selected. The preferred function may be determined on the basis of an increase/decrease of the preference 203 as described above.

If the controller 103 determines that a user is scanning channels after the preferred function is determined, it displays in the display 101 the GUI including the menu item 1005 corresponding to the determined preferred function (operation S1209).

In another exemplary embodiment, if a user selected the related image content 1002, the GUI including the menu item 1005 corresponding to the preferred function may be directly displayed in the display 101, or the determined preferred function may be directly executed. That is, if a user scans channels, channel information for the image content 1002 relating to the image content 1002 preferred by a user may be provided, or the related image content 1002 may be directly provided.

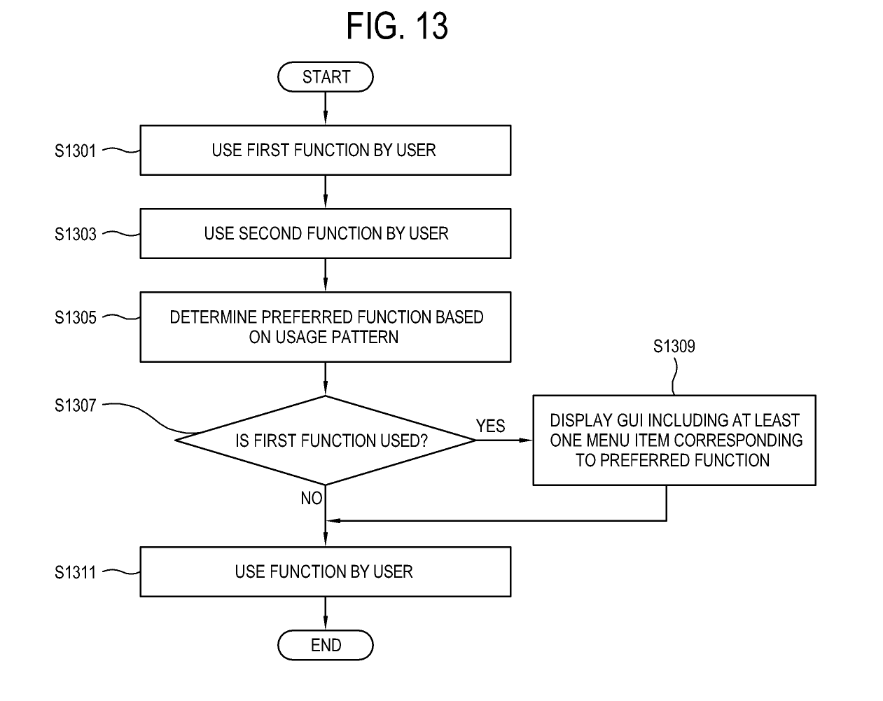

FIG. 13 is a flowchart showing operations of determining and displaying a preferred function based on a function usage pattern of using a second function after a first function is used according to an exemplary embodiment. At operation S1301, a user uses a first function. At operation S1303, a user uses a second function. At operation S1305, the controller 103 determines the preferred function based on a user's function usage pattern. After the preferred function is determined, the controller 103 determines whether a user uses the first function at operation S1307. If the controller 103 determines that a user uses the first function, it displays in the display 101 the GUI including the menu item 1005 corresponding to the user's preferred function at operation S1309. At operation S1311, a user selects and uses the function 201.

The first and second functions are voluntary functions 201 which a user has selected from a plurality of functions that the display apparatus 10 may provide to a user. If the first function is used and then the second function is used, the display apparatus 10 recognizes a user's linked function usage as a function usage pattern and determines a user's preferred function based on the foregoing. The preferred function may be the second function following the first function used by a user. The preferred function may be determined based on an increase/decrease of the preference 203 as described above.

If a user uses the function 201 after the preferred function is selected, the controller 103 determines whether the function 201 performed is the first function (operation S1309).

If the controller 103 determines that a user has used the first function, it displays in the display 101 the GUI including the menu item 1005 corresponding to the determined preferred function according to a user's manipulation (operation S1309).

In another exemplary embodiment, if a user uses the first function, the GUI including the menu item 1005 corresponding to the preferred function may be directly displayed in the display 101, or the determined preferred function may be directly executed.

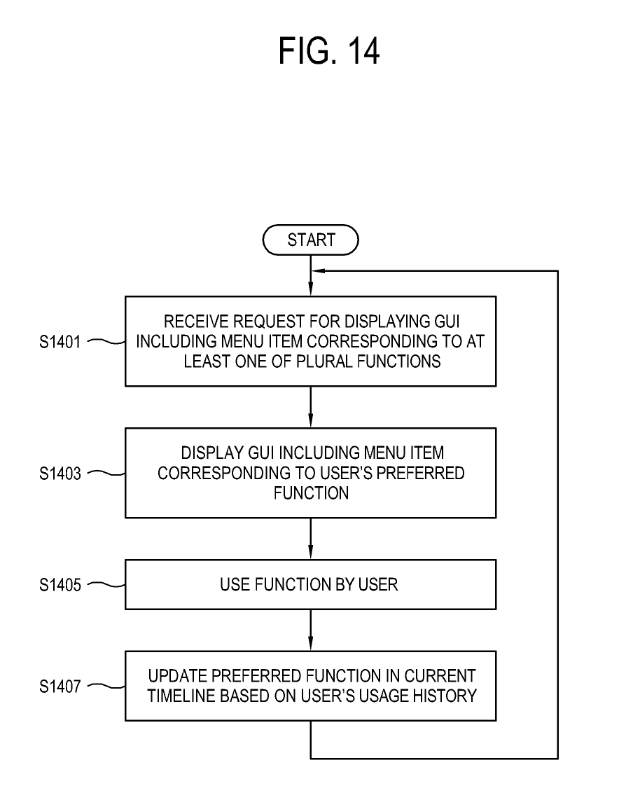

FIG. 14 is a flowchart showing operations of displaying and updating a user's preferred function according to an exemplary embodiment. At operation S1401, a request is made to display the GUI including the menu item corresponding to at least one of the plurality of functions. At operation S1403, the controller 103 displays in the display 101 the GUI including the menu item corresponding to the user's preferred function in the current timeline 200. At operation S1405, a user uses at least one of the functions provided by the display apparatus 10. The controller 103 updates the preferred function in the current timeline 200 based on a user's usage history of functions.

The request for displaying the GUI (operation S1401) may be a user's input of a control command, or may be a control command of the controller 103 to automatically display the GUI according to an algorithm.

Corresponding to the request for displaying the GUI (operation S1401), the controller 103 displays in the display 101 the GUI including the menu item corresponding to a user's preferred function at the requested time, and the time when the display was requested (operation S1403). The GUI displayed as above has been described in detail in FIGS. 6 and 10.

If a user uses the function 201 of the display apparatus 10 for a certain period, the history information on using the function 201 is continuously stored in the storage 105. The controller 103 updates the preferred function in the current timeline based on the user's history information stored in the storage 105 (operation S1407). The process of determining and excluding the preferred function has been described above.

Corresponding to the request for displaying the GUI (operation S1401), the GUI including the menu item corresponding to the newly updated preferred function may be displayed (operation S1403). If the function 201 is determined to be the preferred function, the corresponding menu item is included in the GUI. With respect to a function excluded from the preferred function, the corresponding menu item is removed from the GUI.

As the preferred function is updated based on the usage history (operation S1407), the more a user uses the display apparatus 10, the easier it would be for a user to use the menu item corresponding to the preferred function.

As described, the display apparatus and control method thereof according to the present inventive concept analyzes and provides a user's preferred function in a current timeline to thereby improve usability of a user using the display apparatus.

Although a few exemplary embodiments have been shown and described, it will be appreciated by those skilled in the art that changes may be made in the exemplary embodiments without departing from the principles and spirit of the disclosure.

What is claimed is:

1. A display apparatus comprising:
a display;
a storage; and
a controller configured to:
control the display to display a first graphical user interface (GUI) comprising a plurality of menu items corresponding to a plurality of functions, respectively,
perform a first function, among the plurality of functions, corresponding to a menu item selected by a user among the plurality of menu items,
store, in the storage, history information comprising information on the selected menu item and information on a time when the menu item is selected, and
in response to receiving a request for a GUI, display on the display a second GUI comprising at least one menu item, which is selected based on the history information and a time when the request for the GUI is received.

2. The display apparatus according to claim 1, wherein the controller is configured to increase or decrease a preference rating of at least one function of the plurality of functions based on the history information, determine a second function, among the plurality of functions, having the preference rating equal to or more than a first threshold to be a user's preferred function, and control the display to display the second GUI comprising the at least one menu item corresponding to the user's preferred function.

3. The display apparatus according to claim 2, wherein the controller is configured to exclude a third function, among the plurality of functions, having the preference rating equal to or less than a second threshold as being the user's preferred function.

4. The display apparatus according to claim 2, wherein the controller is configured to additionally increase or decrease the preference rating of the at least one function based on a frequency of the user selecting the menu item corresponding to the at least one function.

5. The display apparatus according to claim 2, wherein the controller is configured to increase or decrease the preference rating of the at least one function differently depending on whether the at least one function is the user's preferred function or not.

6. The display apparatus according to claim 1, wherein the controller is configured to determine at least one function of the plurality of functions to be a user's preferred function based on a user's function usage pattern, and control the display to display a third GUI comprising at least one menu item corresponding to the user's preferred function based on the user's function usage pattern, in response to a user's particular function usage pattern with respect to the at least one function being detected.

7. The display apparatus according to claim 6, wherein the user's function usage pattern comprises using the at least one function after at least one of a plurality of image contents is being selected to be displayed.

8. The display apparatus according to claim 6, wherein the user's function usage pattern comprises selecting at least one channel after scanning a plurality of channels.

9. The display apparatus according to claim 6, wherein the user's function usage pattern comprises using a fourth function followed by using a fifth function, among the plurality of functions.

10. The display apparatus according to claim 2, wherein the controller is configured to control the display to display a fourth GUI, for a user to edit the user's preferred function.

11. A control method of a display apparatus comprising:
displaying a first graphical user interface (GUI) comprising a plurality of menu items corresponding to a plurality of functions, respectively;
performing a first function, among the plurality of functions, corresponding to a menu item selected by a user, among the plurality of menu items;
storing history information comprising information on the selected menu item and information on a time when the menu item is selected; and
in response to receiving a request for a GUI, displaying a second GUI comprising at least one menu item, which is selected based on the history information and a time when the request for the GUI is received.

12. The control method according to claim 11, wherein the displaying the second GUI comprises:
increasing or decreasing a preference rating of at least one function of the plurality of functions based on the history information;
determining a second function, among the plurality of functions, having the preference rating equal to or more than a first threshold to be a user's preferred function; and
displaying the second GUI comprising the at least one menu item corresponding to the user's preferred function at the time when the request for the GUI is received.

13. The control method according to claim 11, wherein the displaying the second GUI further comprises excluding a third function, among the plurality of functions, having the preference rating equal to or less than a second threshold as being the user's preferred function.

14. The control method according to claim 12, wherein the displaying the second GUI further comprises additionally increasing or decreasing the preference rating of the at least one function based on a frequency of the user selecting the menu item corresponding to the at least one function.

15. The control method according to claim 12, wherein the increasing or decreasing the preference rating comprises increasing or decreasing the preference rating of the at least one function differently depending on whether the at least one function is the user's preferred function or not.

16. The control method according to claim 11, further comprises:
determining at least one function of the plurality of functions to be a user's preferred function based on a user's function usage pattern; and
displaying a third GUI comprising at least one menu item corresponding to the user's preferred function based on the user's function usage pattern, in response to a user's particular function usage pattern with respect to the at least one function being detected.

17. The control method according to claim 16, wherein the user's function usage pattern comprises using the at least one function after at least one of a plurality of image contents is being selected to be displayed.

18. The control method according to claim 16, wherein the user's function usage pattern comprises selecting at least one channel after scanning a plurality of channels.

19. The control method according to claim 16, wherein the user's function usage pattern comprises using a fourth function followed by using a fifth function, among the plurality of functions.

20. The control method according to claim 12, further comprises displaying a fourth GUI for a user to edit the user's preferred function.
